(19) United States
(12) Patent Application Publication
(10) Pub. No.: US 2025/0006948 A1
(43) Pub. Date: Jan. 2, 2025

(54) LITHIUM-ION BATTERY COMPONENT WITH MULTI-LAYER ELECTRODE

(71) Applicant: FORD GLOBAL TECHNOLOGIES, LLC, DEARBORN, MI (US)

(72) Inventors: Zijie Lu, Novi, MI (US); Minghong Liu, Northville, MI (US); Celia Cunningham, Detroit, MI (US)

(21) Appl. No.: 18/342,206

(22) Filed: Jun. 27, 2023

(51) Int. Cl. H01M 4/80; H01M 4/66; H01M 10/0525

(52) U.S. Cl. CPC H01M 4/808; H01M 4/661; H01M 4/663; H01M 4/667; H01M 10/0525

(57) ABSTRACT

The present disclosure relates to a secondary solid-state battery, with a current collector configuration that includes a metal foam sandwiched between two microporous carbon layers. The current collector directly interfaces with both the negative electrode and the solid electrolyte separator. Alternatively, the current collector can comprise an elastomer sandwiched between a pair of metal foil layers, enabling responsive expansion and contraction in accordance with the electrodes' changes during charge-discharge cycles. Another embodiment contemplates a carbon fiber paper current collector situated between two microporous layers.

### TECHNICAL FIELD

This disclosure relates to electrode materials for lithium-ion batteries.

### BACKGROUND

Advancements in battery technology may affect progress in various fields, including electric vehicles and portable electronics. Solid-state batteries (SSBs) have been receiving attention due to their potentially increased specific and volumetric energy densities. To maximize the benefits of SSBs, metallic anodes such as lithium (Li) or silicon (Si) are typically used.

These anodes, however, may be subject to large volume change during battery charge and discharge. This volume change may require stack pressures (ranging from 5-50 MPa) to maintain interfacial contact within cells. Moreover, even with these stack pressures, performance degradation may occur with Li or Si SSBs. This is partly due to stress fluctuations and the resultant strain accumulation in the electrodes.

### SUMMARY

This disclosure relates to a design for a secondary SSB. The battery is comprised of a negative electrode, a solid electrolyte separator, and a current collector. The current collector features a configuration in which a metal foam is enclosed between two microporous carbon layers. One of these carbon layers maintains direct areal contact with the negative electrode, while the other contacts the solid electrolyte separator. This configuration results in the surfaces of the current collector being smoother than those of the metal foam.

The microporous carbon layers, which may consist of nano-sized carbon particles, can be coated on the metal foam. The metal foam could be a copper (Cu) metal foam, and its thickness is intended to be greater than that of each of the microporous carbon layers.

Additionally, the design could include a positive electrode, which maintains direct areal contact with the solid electrolyte separator. When these components—the positive electrode, the current collector, the solid electrolyte separator, and the negative electrode—are combined, they form an electrode assembly. The battery may feature several such assemblies, with carbon fiber papers interleaved between them so that not all neighboring assemblies are in direct contact. Instead, some are separated by a carbon fiber paper.

Another contemplated embodiment involves the current collector being composed of an elastomer sandwiched between two metal foil layers. These layers are arranged such that one maintains direct areal contact with the positive electrode while the other contacts the solid electrolyte separator. This structure enables the current collector to compress or expand in response to the expansion or contraction of the positive and negative electrodes during charging and discharging, respectively.

These metal foil layers could either be of the same material or different materials, and the elastomer could potentially be silicone rubber. Once again, these components—the positive electrode, the current collector, the solid electrolyte separator, and the negative electrode—could form an electrode assembly. These assemblies can be multiplied and interleaved with carbon fiber papers.

In another embodiment, the current collector might be a carbon fiber paper current collector. In this contemplated embodiment, the current collector includes a carbon fiber layer sandwiched between two microporous layers, with the surface roughness of the carbon fiber layer being compensated for by a coating of the microporous layer.

### BRIEF DESCRIPTION OF THE DRAWINGS

FIG. 1A is a schematic cross-section of a current collector comprising carbon fiber paper;

FIG. 1B is a schematic cross-section of an anode coating on a current collector;

FIG. 2A is a schematic cross-section of a single cell arrangement with a carbon fiber paper current collector;

FIG. 2B is a schematic cross-section of a cell stack arrangement with a carbon fiber paper current collector;

FIG. 3 is a schematic cross-section of carbon fiber paper as a strain buffer in a secondary SSB cell stack;

FIG. 4 is a schematic cross-section of an elastic material sandwiched between two metal foils;

FIG. 5 is a schematic diagram of a microporous layer coated metal foam; and

FIG. 6 is a schematic diagram of a conductive polymer current collector in a secondary SSB cell.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Measures that can mitigate stress fluctuation, ease strain accumulation, and reduce the need for stack pressure are desirable. Such measures could enhance cycle stability and battery life, representing a significant advancement in battery technology. The disclosed embodiments may mitigate the challenges associated with volume change in SSBs. They introduce an elastic and conductive layer that can serve as the current collector or a separate strain buffer. This layer can be used in SSBs that display significant volume change during charge and discharge, such as those based on metallic anodes, like Li metal and Si.

The electrical conductivity of this layer should exceed 1 S/cm, ideally surpassing 10 S/cm. To accommodate the SSB anode volume change, the elasticity of the layer should be able to compensate for strains, for instance, a strain of 40% at a compressive stress of 1.5 MPa. Ideally, the layer should have a compressive elastic modulus ranging between 1 and 10 MPa, and a strain range (up to 60%). The layer's thickness should be small, ideally less than 80 micrometers in an uncompressed state.

In one embodiment carbon fiber paper may be used as the current collector. In another embodiment a microporous layer composed of nano-sized carbon particles ensures a smooth surface for coating the Si anode layer. In another embodiment, a sandwich configuration of elastic material between two metal layers in contemplated. In this design, an elastic material (like silicone rubber) is sandwiched between two metal foils. The metal foils provide electrical connection, and the spring-like middle layer contracts when the electrode expands, thereby releasing the strain of electrode active materials. When the active materials contract, the layer rebounds to keep the particles in tight contact. The elastic material's properties, such as the elastic modulus and thickness, can be tailored to meet the expanding and contracting requirements. The metal foil's thickness could be in the 2˜5 μm range to minimize the total thickness of the current collector. The metal foils could be the same metal (such as Cu foils or Al foils) or different metals (one side could be a Cu foil, the other side an Al foil).

In another embodiment a metal foam can be used as the main elastic component, with a microporous (carbon) layer coated on top of it to tune the surface roughness and enhance the electrical contact. The elastic properties of the metal foam can be engineered as desired. A microporous layer, composed of nano-sized carbon particles, is used to ensure a smooth surface for coating the Si anode layer.

The disclosure pertains to cycle stability, thus increasing the lifespan of metallic anode based SSBs. Another potential benefit of the disclosure is the reduction of operating stack pressure, which is currently challenging for battery packaging in electric vehicles. This disclosure has the potential to lower the stack pressure to less than 1 MPa, thus simplifying the battery packaging.

Moreover, the contemplated embodiments do not increase battery manufacturing complexity. For instance, the new current collector is a direct replacement for the current metal foil in the roll-to-roll process. The strain buffer layer can be readily inserted between the single cells.

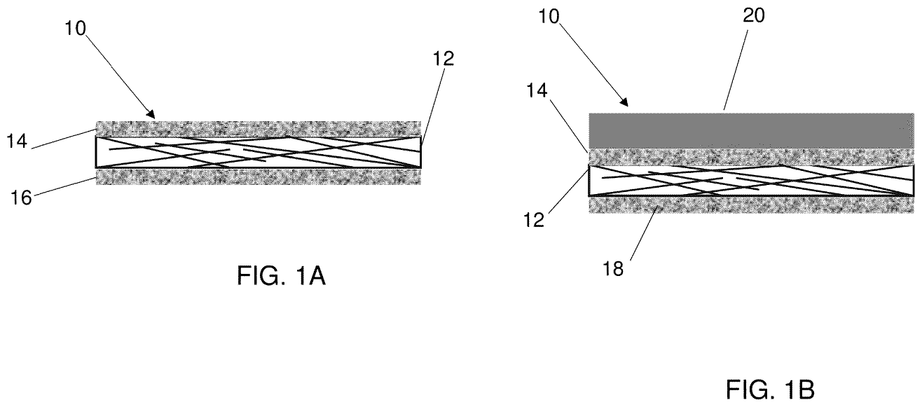

FIG. 1A provides an illustrated embodiment of the carbon fiber paper. This carbon fiber paper, denoted as numeral 10, is a composite structure, comprising a core carbon fiber layer 12 encapsulated between two microporous layers, denoted by numerals 14 and 16 respectively. The microporous layers, 14 and 16, comprise a multitude of nano-sized carbon particles 18, which are effectively embedded within them.

The presence of these microporous layers 14, 16 on both sides of the carbon fiber layer 12 not only contribute to the enhanced mechanical stability of the carbon fiber paper 10 but also serve to render its surface smoother. This enhanced surface smoothness is advantageous when subsequent coating of a Si anode layer is undertaken, aiding in adhesion and uniform coverage of the layer.

In one embodiment, the carbon fiber paper 10 operates as the current collector within the construct of an SSB. In this function, it is configured such that one of the microporous layers, say 14, is in direct areal contact with a negative electrode, whereas the other microporous layer, say 16, is in direct areal contact with a solid electrolyte separator. The outcome of this arrangement ensures that the surfaces of the current collector are smoother than the surfaces of a constituent metal foam.

Transitioning to FIG. 1B, the process of coating a Si anode slurry, denoted as numeral 20, onto the carbon fiber paper 10 is depicted. Once applied, the Si anode slurry 20 assumes the role of the negative electrode.

Notably, the incorporation of nano-sized carbon particles 18 within the microporous layers 14, 16, serves to enhance conductivity and promote efficient electron transfer within the battery. In certain embodiments, the carbon fiber layer 12 could take the form of a metal foam, such as Cu. The dimensions of this metal foam layer could be such that its thickness exceeds that of each of the microporous carbon layers 14, 16.

Following the coating process, the solid electrolyte separator is applied, such that it directly contacts one of the microporous layers, 16, of the carbon fiber paper 10. Furthermore, in some configurations, a positive electrode may be introduced into the battery structure, arranged so that it is in direct areal contact with the solid electrolyte separator.

This outlined configuration forms an integrated electrode assembly comprising the positive electrode, current collector, which can be the carbon fiber paper 10, solid electrolyte separator, and negative electrode, which can be applied as a Si slurry. Multiple such electrode assemblies, along with carbon fiber papers, can be assembled in an interleaved manner. Adjacent pairs of the electrode assemblies can be separated by one of the carbon fiber papers.

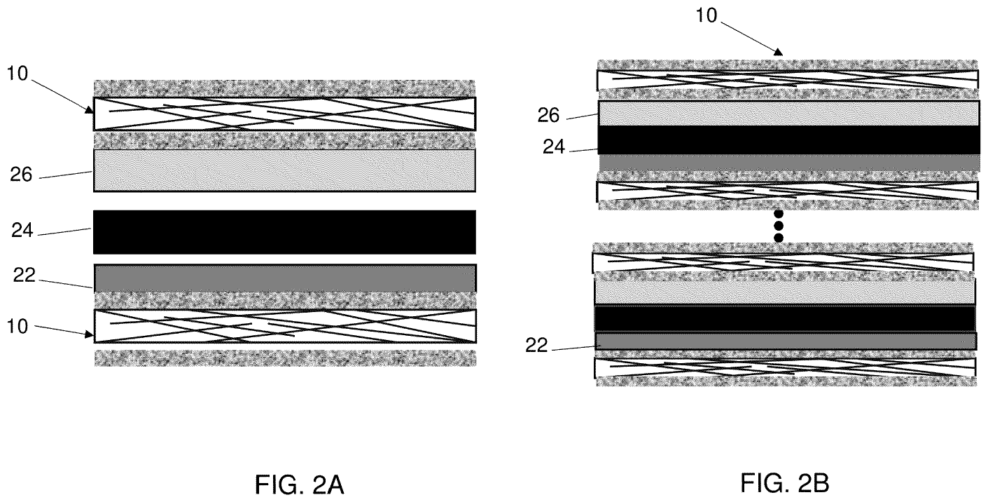

Continuing onto FIG. 2A, a battery cell structure in the mentioned embodiment is illustrated. The battery cell comprises the carbon fiber paper 10 as the base layer. Over this base layer, a Si anode layer 22 is deposited, representing the negative electrode in this battery cell structure. The Si anode layer 22 directly interfaces with the microporous layer 14 of the carbon fiber paper 10, benefiting from the smoother surface provided by the microporous layer.

Following the Si anode layer 22, a solid electrolyte separator 24 is applied, which directly interfaces with the second microporous layer 16 of the carbon fiber paper 10. The solid electrolyte separator 24 facilitates ion transport between the battery's electrodes while preventing direct electronic contact between them.

Atop the solid electrolyte separator 24, a cathode layer 26 is applied, forming the positive electrode of the battery cell structure. The complete structure is then finished with a layer of the carbon fiber paper 10, forming a single battery cell. This configuration represents a coherent electrode assembly, integrating a positive electrode (cathode layer 26), a current collector (carbon fiber paper 10), a solid electrolyte separator 24, and a negative electrode (Si anode layer 22).

Transitioning to FIG. 2B, it presents an embodiment of the bipolar arrangement of the battery cells. Here, another complete battery cell structure, similar to the one in FIG. 2A, is stacked over the existing structure. Each cell in the stack maintains the same order of layers as a single cell, starting with carbon fiber paper 10 at the base, followed by a Si anode layer 22, a solid electrolyte separator 24, a cathode layer 26, and completed with a carbon fiber paper 10.

This bipolar stacking design allows for enhanced energy density by allowing the series connection of multiple cells. The bipolar configuration permits both anodes and cathodes to share current collectors, reducing the total weight and volume of the battery, leading to a more compact and efficient design. As a result, such a design accommodates multiple electrode assemblies and carbon fiber papers in an interleaved manner, where only some adjacent pairs of the electrode assemblies are separated by one of the carbon fiber papers. This compact arrangement of layers in the bipolar configuration optimizes the battery's performance and efficiency.

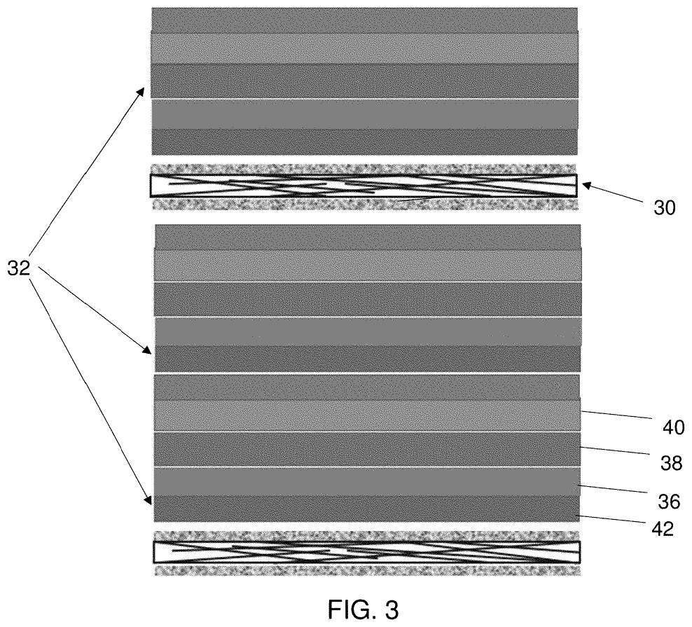

Referring now to FIG. 3, an expanded battery stack is illustrated. The configuration begins with a carbon fiber paper, denoted as numeral 30, serving as the base layer. This layer is followed by two single battery cells, denoted as numeral 32. Each of these single cells 32 includes several components: a Si anode 34, a solid electrolyte separator 36, a cathode 38, and a substrate layer. The cathode substrate can be an aluminum (Al) foil 40, and the anode's substrate can be a Cu foil 42. Upon these components, another layer of the carbon fiber paper 30 is placed, followed by a subsequent single cell 32.

In this particular arrangement, the Si anode 34 is coated on the Cu foil 42, following conventional battery manufacturing techniques. However, what differentiates this structure is the integration of the carbon fiber paper 30 as a strain buffer layer. This layer's role is to help dissipate mechanical stresses, promoting the overall durability and longevity of the battery cell.

Notably, it is not necessary to include the carbon fiber paper 30 for every single cell 32. Depending on experimental determinations and the desired properties of the battery, this layer might be included after every 3 to 5 single cells, for instance. The exact placement will be determined based on experimental results. By reducing the number of carbon fiber papers 30 in the stack, the configuration becomes more compact, thus enhancing the volumetric energy density of the battery.

The complete structure represents a secondary SSB. It incorporates several electrode assemblies, each of which includes positive and negative electrodes, a solid electrolyte separator 36 situated between the positive and negative electrodes, and a current collector in direct areal contact with the negative electrode. In this design, the negative electrode (Si anode 34) is lodged between the solid electrolyte separator 36 and the current collector (carbon fiber paper 30).

The secondary SSB configuration also employs carbon fiber papers 30 interleaved with the electrode assemblies. In this layout, some but not all adjacent pairs of the electrode assemblies are separated by one of the carbon fiber papers 30.

In an additional aspect of the depicted embodiment, the current collector can incorporate a carrier film to support the structural integrity and better adhesion with the negative electrode. A viable choice for this carrier film could be a polyimide substrate due to its mechanical and thermal stability. This polyimide substrate could be coated with a layer of poly 3,4-ethylenedioxythiophene polystyrene sulfonate, a conductive polymer, to boost the current collection capacity of the current collector.

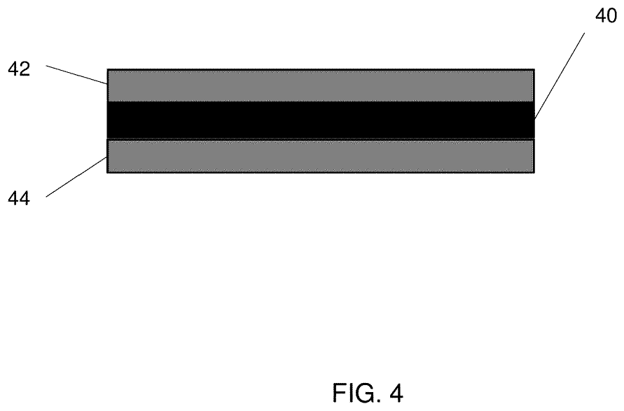

Shifting now to FIG. 4, which presents a configuration of an elastic material 40 enveloped between two metal foils 42 and 44. Specifically, in this configuration, an elastomeric material, such as silicone rubber, is utilized as the central layer, creating a resilient structure that is adaptable to the expanding and contracting behavior of the battery components.

The role of the metal foils 42 and 44 is multifaceted. Primarily, they serve as conduits providing electrical connection. Additionally, they act in conjunction with the elastic material 40 to form a compressible structure. This “spring-like” middle layer is designed to contract when the electrode expands during charge cycles, thereby releasing strain experienced by the electrode active materials. Conversely, it bounds back or expands when the active material shrinks during discharge cycles, ensuring the particles remain in tight contact.

These adaptive behaviors are helpful for maintaining the integrity of the battery, enhancing its durability and performance. It should be noted that the properties of the elastic material 40, such as its elastic modulus and thickness, can be precisely engineered to meet the specific expanding and contracting requirements of the battery.

In order to maintain the compact design of the battery and minimize the total thickness of the current collector, the thickness of the metal foils 42 and 44 can be kept within the 2˜5 um range. This careful balance ensures the battery retains its energy density while incorporating the strain-relief benefits of the elastic layer 40.

Depending on the design needs and performance requirements, the metal foils 42 and 44 can be made from the same material or different materials. In some configurations, both could be Cu, Al, or any other conductive material that suits the application requirements. In other instances, the metal foils might consist of different materials to optimize certain properties, such as conductivity, mechanical strength, or corrosion resistance.

A secondary SSB configuration incorporates this current collector design with an elastomeric material sandwiched between two metal foils. In this configuration, the negative electrode and the positive electrode are separated by a solid electrolyte separator, and one of the metal foils of the current collector is in direct areal contact with the positive electrode while the other is in contact with the solid electrolyte separator.

The entire configuration consisting of the positive and negative electrodes, solid electrolyte separator, and the uniquely designed current collector forms an electrode assembly. The battery can further comprise a plurality of these electrode assemblies and carbon fiber papers interleaved with the electrode assemblies. This arrangement ensures that some but not all adjacent pairs of electrode assemblies are separated by one of the carbon fiber papers, enhancing the mechanical stability and performance of the battery.

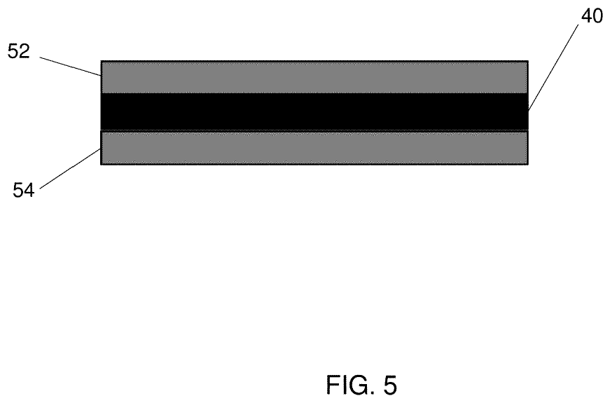

Turning now to FIG. 5, a novel design configuration is presented. Here, a metal foam 50 serves as the primary elastic component, enveloped by two microporous layers 52 and 54. These microporous layers are comprised of nano-sized carbon particles and offer a number of functionalities to the overall system.

The microporous layers 52 and 54 serve as a vital interface, contributing to both the mechanical and electrical properties of the assembly. They function to tune the surface roughness of the metal foam 50, creating a more even and conducive surface. This smooth surface becomes ideal for the subsequent coating of the Si anode layer, aiding in the enhancement of its adhesion and uniformity. The microporous layers 52 and 54 also play a pivotal role in enhancing electrical contact, contributing to conductivity within the assembly.

The metal foam 50 at the core of this design has been chosen due to its inherent elasticity. This elasticity allows it to respond to the expansion and contraction of the electrodes during the charge-discharge cycles of the battery, thus enhancing durability and reliability. The elastic properties of this metal foam 50 can be carefully engineered to meet the desired specifications, ensuring optimal performance in response to the active material's mechanical behavior.

The described configuration is integrated into a secondary SSB in which a current collector comprises this metal foam 50 sandwiched between the microporous layers 52 and 54. The positive electrode and the negative electrode are separated by a solid electrolyte separator, and one of the microporous layers of the current collector is in direct areal contact with the positive electrode, while the other is in contact with the solid electrolyte separator.

The entirety of this assembly—comprising the positive and negative electrodes, the solid electrolyte separator, and the uniquely designed current collector—forms an electrode assembly. The battery design may include multiple such electrode assemblies. Further, carbon fiber papers may be interleaved with these assemblies such that not all adjacent pairs of electrode assemblies are in direct contact. Instead, some are separated by a carbon fiber paper, providing additional mechanical stability and enhancing the battery's overall performance.

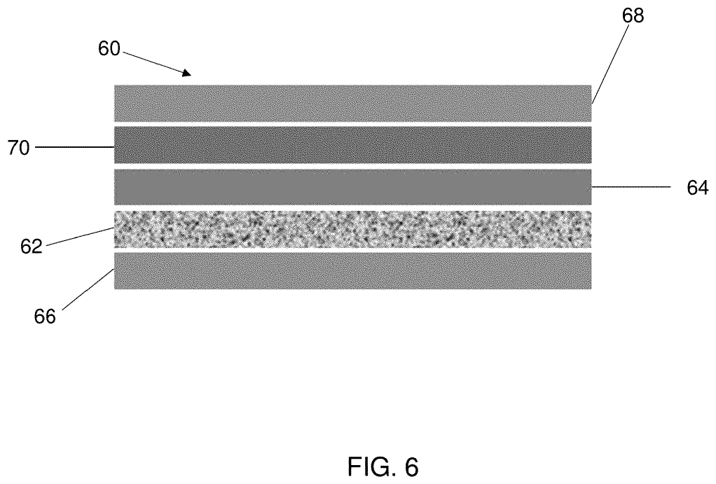

Referring now to FIG. 6, a secondary SSB cell configuration 60 is introduced. In this embodiment, a strain buffer layer and current collector in one, a poly 3,4-ethylenedioxythiophene polystyrene sulfonate (PEDOT-PSS) layer 62, forms a fundamental component. The anode layer 64, which can be a Si anode can be coated directly on this PEDOT-PSS layer.

The PEDOT-PSS layer 62 is itself coated on a carrier film 66, such as an insulating polyimide substrate. This polyimide substrate serves to provide structural support to the PEDOT-PSS layer 62, enhancing the overall mechanical stability of the SSB cell 60.

However, this carrier film 66 can either be retained or removed in the SSB stack, depending on the specific battery configuration. For example, it might be removed in a bipolar stack configuration to optimize for space and material efficiency.

To further increase the mechanical strength of the conductive polymer current collector (PEDOT-PSS) 62, the layer may be reinforced with other porous substrates or polymer materials. These could include expanded polytetrafluoroethylene (e-PTFE), glass fibers, cellulose substrate, or polyvinylidene fluoride-hexafluoropropylene (PVDF-HFP), amongst other options. These reinforcements ensure that the current collector is robust and able to endure the mechanical stresses experienced during battery operation.

The SSB cell 60 as a whole consists of a positive electrode 68, a solid electrolyte separator 70, a negative electrode 64, and the current collector 62. The current collector 62, containing the PEDOT-PSS layer, is in direct areal contact with the negative electrode 64. The negative electrode 64, in turn, is positioned between the solid electrolyte separator 70 and the current collector 62.

The arrangement comprising the positive electrode 68, the solid electrolyte separator 70, the negative electrode 64, and the current collector 62 forms an electrode assembly. These assemblies can be used to create a secondary SSB comprising multiple such assemblies. Furthermore, carbon fiber papers can be interleaved with these assemblies such that not all adjacent pairs of electrode assemblies are in direct contact. Instead, some are separated by a carbon fiber paper, offering additional mechanical stability and enhancing the battery's overall performance.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A secondary solid-state battery comprising:
a negative electrode;
a solid electrolyte separator; and
a current collector including a metal foam sandwiched between a pair of microporous carbon layers such that (i) one of the microporous carbon layers is in direct areal contact with the negative electrode and the other of the microporous carbon layers is in direct areal contact with the solid electrolyte separator and (ii) surfaces of the current collector are smoother than surfaces of the metal foam.

2. The battery of claim 1, wherein the microporous carbon layers are coated on the metal foam.

3. The battery of claim 1, wherein the microporous carbon layers include nano sized carbon particles.

4. The battery of claim 1, wherein the metal foam is a copper metal foam.

5. The battery of claim 1, wherein a thickness of the metal foam is greater than a thickness of each of the microporous carbon layers.

6. The battery of claim 1, further comprising a positive electrode in direct areal contact with the solid electrolyte separator.

7. The battery of claim 6, wherein the positive electrode, current collector, solid electrolyte separator, and negative electrode form an electrode assembly, further comprising a plurality of the electrode assemblies and carbon fiber papers interleaved with the electrode assemblies such that some but not all adjacent pairs of the electrode assemblies are separated by one of the carbon fiber papers.

8. A secondary solid-state battery comprising:
positive and negative electrodes;
a solid electrolyte separator between the positive and negative electrodes; and
a current collector including an elastomer sandwiched between a pair of metal foil layers such that (i) one of the metal foil layers is in direct areal contact with the positive electrode and the other of the metal foil layers is in direct areal contact with the solid electrolyte separator, (ii) the current collector compresses responsive to expansion of the positive and negative electrodes during charge, and (iii) the current collector expands responsive to contraction of the positive and negative electrodes during discharge.

9. The battery of claim 8, wherein the metal foil layers are a same material.

10. The battery of claim 8, wherein the metal foil layers are different materials.

11. The battery of claim 8, wherein the elastomer is a silicone rubber.

12. The battery of claim 8, wherein the positive electrode, current collector, solid electrolyte separator, and negative electrode form an electrode assembly, further comprising a plurality of the electrode assemblies and carbon fiber papers interleaved with the electrode assemblies such that some but not all adjacent pairs of the electrode assemblies are separated by one of the carbon fiber papers.

13. A secondary solid-state battery comprising:
a plurality of electrode assemblies, each of the electrode assemblies including positive and negative electrodes, a solid electrolyte separator between the positive and negative electrodes, and a current collector in direct areal contact with the negative electrode such that the negative electrode is between the solid electrolyte separator and current collector, wherein the current collector is a carbon fiber paper current collector including a carbon fiber layer sandwiched between a pair of microporous layers; and
a plurality of carbon fiber papers interleaved with the electrode assemblies.

14. The battery of claim 13, wherein rough surfaces of the carbon fiber layer are filled in by the microporous layers.

15. The battery of claim 13, wherein some but not all adjacent pairs of the electrode assemblies are separated by one of the carbon fiber papers.
